(19) United States
(12) Patent Application Publication
(10) Pub. No.: US 2026/0184998 A1
(43) Pub. Date: Jul. 2, 2026

(54) HYDROPYROLYSIS PROCESS

(71) Applicant: SHELL USA, INC., Houston, TX (US)

(72) Inventors: Harshavardhan Jayant CHOUDHARI, Bangalore North (IN); Patrick VANDER HOOGERSTRAETE, Wondelgem (BE); Pieter HUIZENGA, Amsterdam (NL); Rikeshchandra Sharadchandra JOSHI, Bangalore North (IN)

(21) Appl. No.: 19/128,144

(22) PCT Filed: Nov. 29, 2023
(86) PCT No.: PCT/US2023/081488

§ 371 Date: May 7, 2025

(30) Foreign Application Priority Data
Dec. 5, 2022 (IN) 202241070002

(51) Int. Cl. C10G 1/08; B01J 21/04; B01J 23/883; B01J 27/19; B01J 35/30; B01J 35/32; B01J 35/61; B01J 35/63; B01J 35/64; B01J 37/02; B01J 37/08; C10G 1/00; C10G 1/06

(52) U.S. Cl. CPC C10G 1/086; B01J 21/04; B01J 23/883; B01J 27/19; B01J 35/32; B01J 35/394; B01J 35/613; B01J 35/633; B01J 35/647; B01J 37/0205; B01J 37/088; C10G 1/002; C10G 1/06; C10G 2300/1003; C10G 2300/1014

(57) ABSTRACT

The present invention provides a process for the hydropyrolysis of biomass, said process comprising the steps of contacting biomass with a hydropyrolysis catalyst in a bubbling fluidised bed reactor under a hydrogen atmosphere, wherein the hydropyrolysis catalyst is prepared by a process comprising the steps of impregnating a gamma alumina carrier with a first impregnation solution comprising a tungsten salt, drying the tungsten-impregnated carrier; then impregnating the dried tungsten-impregnated carrier with a second impregnation solution comprising a source of a metal selected from those in groups 8, 9 and 10 of the periodic table, and, optionally, a molybdenum source, drying the fully impregnated carrier and then calcining it.

### FIELD OF THE INVENTION

This invention relates to a hydropyrolysis process and a method for preparing a catalyst for use therein.

### BACKGROUND OF THE INVENTION

With increasing demand for liquid transportation fuels, decreasing reserves of ‘easy oil’ (crude petroleum oil that can be accessed and recovered easily) and increasing constraints on the carbon footprints of such fuels, it is becoming increasingly important to develop routes to produce liquid transportation fuels from alternative sources in an efficient manner.

Biomass offers a source of renewable carbon and refers to biological material derived from living or recently deceased organisms and includes lignocellulosic materials (e.g., wood), aquatic materials (e.g., algae, aquatic plants, and seaweed) and animal by-products and wastes (e.g., offal, fats, and sewage sludge). Liquid transportation fuels produced from biomass are sometimes referred to as biofuels. Therefore, when using such biofuels, it may be possible to achieve more sustainable CO₂ emissions over petroleum-derived fuels.

However, in the conventional pyrolysis of biomass, typically fast pyrolysis carried out in an inert atmosphere, a dense, acidic, reactive liquid bio-oil product is obtained, which contains water, oils and char formed during the process. The use of bio-oils produced via conventional pyrolysis is, therefore, subject to several drawbacks. These include increased chemical reactivity, water miscibility, high oxygen content and low heating value of the product. Often these products are difficult to upgrade to fungible liquid hydrocarbon fuels.

An efficient method for processing biomass into high quality liquid fuels is described in WO2010117437 and subsequent patents describing the IH² process developed by Shell and Gas Technology Institute, such as U.S. Pat. Nos. 10,005,965, 9,868,909, 10,005,964, US20170009143, U.S. Pat. Nos. 10,167,429, 10,526,544, 11,174,438, 10,822,545, 10,174,259, 10,190,056, 10,774,270, 10,829,695, 10,647,924, 10,822,546, 9,657,232, 10,183,279 and WO2022133224. The processes for the conversion of biomass into liquid hydrocarbon fuels described in WO2010117437 and subsequent patents use a first hydropyrolysis reaction and a subsequent hydroconversion reaction to convert biomass into useable products.

Solid feedstocks such as feedstocks containing waste plastics and feedstocks containing lignocellulose (e.g., woody biomass, agricultural residues, forestry residues, residues from the wood products and pulp & paper industries and municipal solid waste containing lignocellulosic material) are important feedstocks for biomass to fuel processes due to their availability on a large scale. Lignocellulose comprises a mixture of lignin, cellulose and hemicelluloses in any proportion and usually also contains ash and moisture.

The hydropyrolysis stage of the process described in WO2010117437 and subsequent patents utilises a hydropyrolysis catalyst. Typical hydropyrolysis catalysts used in this process comprise a mixture of cobalt or nickel in combination with molybdenum and phosphorus on a gamma alumina carrier. The hydropyrolysis reaction takes place in a bubbling fluidised bed reactor in which biomass is fed to the bottom of the reactor. The biomass is rapidly heated in contact with hot hydropyrolysis catalyst under a hydrogen atmosphere. The catalyst must have certain properties with respect to size and density in order to achieve a fluidised bed with the necessary flow and reaction rate. Some catalyst will pass out of the top of the bed and must be separated from the hydropyrolysis product and char. Optimising the density of the catalyst particles would facilitate separation from the char and allow catalyst to quickly pass through downcomers and to be rapidly returned to the main reactor body with minimal heat loss.

As well as being of the correct size and density for the hydropyrolysis process, the hydropyrolysis catalyst must retain the metal loading ability and surface area required to provide the necessary catalytic activity. Tailoring the hydropyrolysis process to produce a desirable product slate would also be advantageous.

### SUMMARY OF THE INVENTION

The present invention provides a process for the hydropyrolysis of biomass, said process comprising the steps of contacting biomass with a hydropyrolysis catalyst in a bubbling fluidised bed reactor under a hydrogen atmosphere, wherein the hydropyrolysis catalyst is prepared by a process comprising the steps of impregnating a gamma alumina carrier with a first impregnation solution comprising a tungsten salt, drying the tungsten-impregnated carrier; then impregnating the dried tungsten-impregnated carrier with a second impregnation solution comprising a source of a metal selected from those in groups 8, 9 and 10 of the periodic table, and, optionally, a molybdenum source, drying the fully impregnated carrier and then calcining it.

### DETAILED DESCRIPTION OF THE INVENTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present inventors have surprisingly found that a process for the rapid hydropyrolysis of biomass may be carried out using a hydropyrolysis catalyst prepared by initially impregnating a suitable carrier with a tungsten salt before subsequently impregnating it with at least one suitable metal salt. The thus-prepared catalyst has been demonstrated to provide excellent catalyst density for effective use in a bubbling fluidised bed reactor of the type used in fast hydropyrolysis reactions such as those used in the IH² process, while providing excellent catalyst activity within said fluidised catalyst bed.

The catalyst prepared in the present invention comprises a gamma alumina carrier. The carrier may optionally contain other refractory oxides, such as silica and/or titanium oxide. However, a preferred carrier consists essentially of gamma alumina.

Average catalyst particles sizes, for use in a commercial fluidised bed reactor for hydropyrolysis, are preferably in the range of from 0.30 mm to 0.60 mm, more preferably in the range of from 0.40 mm to 0.60 mm, and most preferably in the range of from 0.45 mm to 0.55 mm.

To achieve such an average catalyst particle size, a carrier formed in particles within the same average size limits must be used.

The gamma alumina carrier used in the process of the present invention may be any suitable shape typically utilised in carriers for use in commercial reactors. The gamma alumina carrier used in the process of the present invention is preferably a spherical carrier. Most preferably the gamma alumina carrier is in the form of spherical carrier particles with an average particle diameter in the range of from 0.45 to 0.55 mm.

In a first step of the preparation of the catalyst for use in the process of the present invention, the gamma alumina carrier is impregnated with a first impregnation solution comprising a tungsten salt. Impregnation may be achieved by contacting the catalyst carrier with a solution of a suitable soluble tungsten salt in a small amount of solvent. Suitable tungsten salts include, but are not limited to, ammonium metatungstate and tungstic acid. A particularly preferred tungsten salt is ammonium metatungstate.

The incorporation of the first impregnation solution into the gamma alumina carrier may be done by any suitable means or method known to those skilled in the art. Such method may include standard impregnation by incipient wetness or even soaking the shaped support with an excess amount of the metal-containing impregnation solution than would be used in a dry impregnation or an incipient wetness impregnation. A typical method of carrier impregnation is pore volume impregnation, which involves using an amount of the salt solution equivalent to that required to fill the pore volume of the carrier.

The concentration of the tungsten compounds in the first impregnation solution is selected so as to provide the desired tungsten content in the hydropyrolysis catalyst, taking into consideration the pore volume of the carrier into which the first impregnation solution is to be impregnated. Typically, the concentration of tungsten compound in the first impregnation solution is in the range of from 0.01 to 20 moles per litre.

The tungsten is suitably incorporated into the catalyst carrier in an amount that would result in tungsten being present in the hydropyrolysis catalyst in an amount in the range of from 10 to 35 wt %, preferably from 15 wt % to 30 wt %, and, most preferably, from 20 wt % to 30 wt % based on the overall weight of the catalyst.

The tungsten-impregnated carrier is then dried under drying conditions that include a drying temperature that is less than a calcination temperature. The drying temperature under which the step of drying the tungsten-impregnated carrier is conducted should not exceed a calcination temperature. Thus, the drying temperature should not exceed 400° C., and, preferably, the drying temperature at which the tungsten-impregnated carrier is dried does not exceed 300° C., and, most preferably, the drying temperature does not exceed 250° C. It is understood that this drying step will, in general, be conducted at lower temperatures than the aforementioned temperatures, and, typically, the drying temperature will be conducted at a temperature in the range of from 60° C. to 150° C.

Preferably, the dried tungsten-impregnated carrier is then calcined in the presence of air or oxygen. Said calcination is preferably carried out at a temperature in the range of from 450 to 600° C.

The dried tungsten-impregnated carrier is then subjected to impregnation with further metal sources in order to incorporate the required species in the hydropyrolysis catalyst. In the process of the present invention, a source of a metal selected from those in groups 8, 9 and 10 of the periodic table is used. Preferably, a molybdenum source is also used. For clarity, groups 8, 9 and 10 of the periodic table are those according to “Nomenclature of Inorganic Chemistry”-IUPAC Recommendations 2005. Preferred metals in groups 8, 9 and 10 of the periodic table are selected from one or more of cobalt, iron, nickel, copper and manganese. Even more preferably, the metal or metals in groups 8, 9 and 10 of the periodic table are one or more of cobalt and nickel.

A suitable cobalt source may be selected from any suitable cobalt salt but is preferably selected from one or more of cobalt (II) hydroxide, cobalt hydroxide, cobalt oxide, cobalt (II) nitrate hexahydrate, cobalt hydroxycarbonate and cobalt oxide.

A preferred nickel source is selected from one or more of nickel hydroxide, nickel hydroxycarbonate, nickel nitrate and nickel oxide

Suitable molybdenum sources include, but are not limited to, ammonium heptamolybdate and molybdenum trioxide, ammonium dimolybdate, molybdenum dioxide

Suitably, the metal sources are combined in a solvent to provide a second impregnation solution.

The incorporation of the second impregnation solution into the dried tungsten-impregnated carrier may be done by any suitable means or method known to those skilled in the art. Such method may include standard impregnation by incipient wetness or even soaking the shaped support with an excess amount of the metal-containing impregnation solution than would be used in a dry impregnation or an incipient wetness impregnation. A typical method of carrier impregnation is pore volume impregnation, which involves using an amount of the impregnation solution equivalent to that required to fill the pore volume of the catalyst carrier present.

The concentration of the metal sources in the second impregnation solution is selected so as to provide the desired metal content in the hydropyrolysis catalyst, taking into consideration the pore volume of the dried tungsten-impregnated support into which the second impregnation solution is to be impregnated. Typically, the concentration of each of the metal compounds in the second impregnation solution is in the range of from 0.01 to 10 moles per litre.

When the metal sources include a cobalt source, the preferred metal content of the cobalt in the hydropyrolysis catalyst is typically in an amount in the range of from 0.5 wt % to 20 wt %, preferably from 1 wt % to 15 wt %, and, most preferably, from 2 wt % to 12 wt % based on the overall weight of the catalyst.

When the metal sources include a nickel source, the preferred metal content of the nickel in the hydropyrolysis catalyst is typically in an amount in the range of from 0.5 wt % to 20 wt %, preferably from 1 wt % to 15 wt %, and, most preferably, from 2 wt % to 12 wt % based on the overall weight of the catalyst.

If present, the metal content of the molybdenum in the hydropyrolysis catalyst is typically in an amount in the range of from 5 wt % to 20 wt %, preferably from 8 wt % to 20 wt %, and, most preferably, from 12 wt % to 20 wt % based on the overall weight of the catalyst.

Phosphorus may also be incorporated in the hydropyrolysis catalyst as an active species by also incorporating a phosphorus source in the second impregnation solution. If present, the content of the phosphorus in the hydropyrolysis catalyst is typically in an amount in the range of from 1 wt % to 5 wt %, preferably from 2 wt % to 4 wt %, and, most preferably, from 2 wt % to 3 wt % based on the overall weight of the catalyst.

If a phosphorus source is also included a preferred phosphorous source is phosphoric acid.

The fully impregnated carrier is then dried and calcined.

As with the previous drying step, the drying temperature under which the step of drying the fully impregnated carrier is conducted should not exceed a calcination temperature. Thus, the drying temperature should not exceed 400° C., and, preferably, the drying temperature at which the fully impregnated carrier is dried does not exceed 300° C., and, most preferably, the drying temperature does not exceed 250° C. It is understood that this drying step will, in general, be conducted at lower temperatures than the aforementioned temperatures, and, typically, the drying temperature will be conducted at a temperature in the range of from 60° C. to 150° C.

The dried fully impregnated carrier is then calcined in the presence of air or oxygen. Said calcination is preferably carried out at a temperature in the range of from 450 to 600° C.

In the hydropyrolysis process of the present invention, a biomass feedstock and fluidising gas comprising hydrogen are supplied to a fluidised bed reactor comprising the hydropyrolysis catalyst. The fluidized bed reactor is operated at an elevated temperature and pressure. The term “hydropyrolysis” is used generally to refer to a process by which a biomass feedstock is rapidly heated and thermally decomposed, in the presence of solid catalyst particles in an atmosphere consisting largely of hydrogen gas. A hydropyrolysis process provides a means to remove oxygen from biomass and other feedstocks containing significant quantities of carbon and chemically bonded oxygen to produce light hydrocarbons products with a large portion of the oxygen removed from the feedstock-derived liquid. Hydropyrolysis processes have been described in detail in, among others, U.S. Pat. Nos. 8,492,600 and 8,841,495.

A fluidised bed reactor suitable for use in the hydropyrolysis process of the invention generally comprises a mixing zone, a bulk reactor zone and optionally, an expanded solids disengagement zone (i.e., a section of expanded reactor diameter or cross-sectional area, relative to the diameter or cross-sectional area of the fluidised bed) at a suitable height above the bulk reactor zone in order to promote the separation of solid char particles from solid catalyst particles. The fluidised bed reactor further comprises one or more downcomers fluidly connecting the bulk reactor zone located at or near the top of the reactor to the mixing zone located at or near the bottom part of the reactor.

Fluidisation in the mixing zone and bulk reactor zone of the fluidised bed reactor may be performed with a fluidising gas having a superficial velocity effective for carrying out the type of fluidisation desired (e.g., bubbling bed fluidisation), considering the properties of the biomass feedstock, conditions within the reactor, and the particular fluidising gas being used. In general, a fluidising gas comprising hydrogen will have a superficial velocity of generally greater than about 0.1 meters per second (m/s) (e.g., from about 0.1 m/s to about 20 m/s), greater than 0.2 m/s (e.g. from about 0.2 m/s to about 1.5 m/s), typically greater than about 0.3 m/s (e.g., from about 0.3 m/s to about 1.2 m/s), and often greater than about 0.5 m/s (e.g., from about 0.5 m/s to about 1 m/s). Suitable fluidising gas streams comprise primarily hydrogen but may also contain other non-condensable gases (e. g., CO, CO₂, and/or CH₄).

Preferably, the superficial gas velocity of the fluidising gas in the mixing zone is the same as or higher than that in the bulk reactor zone. Generally speaking, a higher superficial gas velocity in the mixing zone enables the use of larger biomass particles as compared to a standard fluidised bed as they do not sink to the bottom and form deposits. It is within the ability of one skilled in the art to select a suitable combination of superficial gas velocity, length of mixing zone and diameter of mixing zone, taking into consideration, for example, the rate at which the biomass feedstock is fed into the mixing zone, the amount of catalyst circulated and partial pressure of hydrogen within the reactor, the desired residence time of the biomass, catalyst, and fluidising gas, etc. It also within the ability of one skilled in the art to determine a suitable combination of superficial gas velocity, length of mixing zone and diameter of mixing zone such that backmixing of biomass from a bulk reactor zone located above the mixing zone is negligible, taking into consideration, for example, the dimensions of the mixing zone and the bulk reactor zone.

Conditions in the fluidised bed reactor include a temperature generally in the range of from 330° C. to 500° C., preferably from 350° C. to 480° C., more preferably from 370° C. to 450° C. The exact operating temperature depends upon the composition of the feedstock that is to undergo hydropyrolysis, the characteristics of the hydropyrolysis catalyst, and the desired composition of products that is to be obtained. The pressure within the reactor is typically in the range of from 0.50 MPa to 7.50 MPa. The exact operating pressure of the fluidised bed reactor depends upon the composition of the feedstock that is to undergo hydropyrolysis, the choice of catalyst, the composition of the fluidising gas (i.e., the hydrogen rich gas purity) and the desired composition of products that are to be obtained. The weight hourly space velocity (WHSV) in the reactor, calculated as the combined weight flow rate of the biomass feedstock, divided by the weight of the catalyst inventory in the reactor, is generally from about 0.1 hr⁻¹ to about 10 hr⁻¹, typically from about 0.5 hr⁻¹ to about 5 hr⁻¹, and often from about 0.8 hr⁻¹ to about 3 hr⁻¹. In general, the fluidisation velocity, catalyst size and bulk density and feedstock size and bulk density are chosen such that the deoxygenation catalyst remains in the fluidised bed, while the char produced gets entrained out of the reactor.

Such a hydropyrolysis processes produces a hydropyrolysis reactor output comprising a partially deoxygenated hydropyrolysis product (e.g., in the form of a condensable vapour), at least one non-condensable gas (e.g., CO, CO₂, and/or CH₄), and char particles. As used herein, the “partially deoxygenated hydropyrolysis product” may comprise oxygenated hydrocarbons (e.g., derived from cellulose, hemicellulose, and/or lignin) that may be subjected to more complete deoxygenation (e.g., to produce hydrocarbons and remove the oxygen in the form of CO, CO₂, and/or water) in a subsequent (downstream) hydroconversion process. Representative oxygen contents of the partially deoxygenated hydropyrolysis product are generally in the range from about 1 to about 30% by weight, or from about 5 to about 25% by weight.

Following hydropyrolysis all, or substantially all, of the char particles and/or other solid particles (e.g., catalyst fines) are removed from the hydropyrolysis reactor output to provide a purified hydropyrolysis reactor vapour stream having a reduced char content. The method of char and catalyst fines removal is generally not limited and may include any method suitable for use with such hydropyrolysis processes. A preferred method of char and catalyst fines removal from the vapour stream is by cyclone separation. Catalyst particles may also be present in the hydropyrolysis reactor output, and these will be separated. The catalyst used by the process of the present invention advantageously has a suitable density to allow simple separation of the catalyst particles and their return to the fluidized bed without considerably heat loss.

The invention will now be further illustrated by reference to the following non-limiting examples.

### EXAMPLES

### Example 1 (Inventive)

A catalyst was prepared by the process as described herein. The first step involved impregnation of a spherical gamma alumina support having 0.5 mm average diameter, with an ammonium meta tungstate solution. The ammonium meta tungstate concentration in the solution was 400 g/l. After impregnation, the support was dried at a temperature of 120° C. for 6 hours, and then calcined at a temperature of 483° C. for 1 hour. The tungsten-impregnated support was impregnated a second time with an acidic solution comprising cobalt, molybdenum and phosphorous. After impregnation, the catalyst was dried at a temperature of 120° C. for 6 hours, and then calcined at a temperature of 483° C. for 1 hour. The physical properties of the catalyst are summarized in Table 1.

TABLE 1

| | |
|---|---|
| Co, wt % | 2.3 |
| Mo, wt % | 8 |
| W, wt. % | 28 |
| Compacted Bulk density, g/cc | 1.2 |
| Particle density, g/cc | 2 |
| BET Surface area, m²/g | 70 |
| N2 BET Pore volume, cc/g | 0.18 |
| N2 BET Pore Diameter, nm | 9.5 |

The catalyst prepared in Example 1 was used as a hydropyrolysis catalyst in a bubbling fluidised bed reactor. The catalyst was ground and sieved to a particle size range of 300 micron to 500 micron. A second, hydrotreating catalyst (containing nickel and molybdenum on alumina) (CAT B) was dried to remove moisture before weighing. The dried hydrotreating catalyst, in the form of extrudates of 1.3 mm diameter and approximately 3 mm to 6 mm length, was used as the catalyst in a second, fixed bed, reactor. Neither the hydropyrolysis catalyst nor the hydrotreating catalyst underwent any activation treatment (such as sulfidation) prior to loading in the reactor. The solid feedstock used was sawdust generated in a paper and pulp mill as a co-product. The sawdust was sieved to a particle size of 250 micron to 500 micron.

The hydropyrolysis catalyst in the first reactor was fluidised with a stream of hydrogen preheated to a temperature of approximately 435° C. After the hydropyrolysis catalyst had been fluidised, the biomass was introduced into the reactor and processed in a continuous manner. The rate of processing of biomass was gradually ramped up to the target rate of 4.14 g/min, corresponding to a weight hourly space velocity of the biomass feedstock to the first stage reactor of approximately 1.26 kg biomass per kg catalyst per hour. The weighted average temperature of the fluidised bed of catalyst was 414.0° C. over the duration of biomass processing. The biomass feedstock was converted to a mixture of char, ash and vapours in the first reactor. The fluidisation velocity was adjusted in such a way that the solid products (char, ash) and the vapour phase products were carried out of the reactor, while the catalyst remained in the reactor. Some catalyst was attrited into fines, and the fines were carried out of the bed as well. The solid product was separated from the vapour phase product in a filter and the vapours were sent to the second reactor.

The average temperature of the second stage hydrotreating catalyst was maintained at 388.0° C. The biomass feeding rate was gradually ramped up to the final WHSV to the second stage of 0.36 kg biomass per kg catalyst per hour. Operating pressure for both first and second stage was 2260 KPa. The vapour phase product of second stage reactor was cooled in stages to −46° C. and a two-layer liquid product containing a hydrocarbon layer floating on an aqueous layer was recovered. The hydrocarbon liquid was separated from the aqueous liquid and was analysed. The off gas from the process was sent to an online GC, and composition of the gas was analysed throughout the run. The mass balance and carbon balance of the process was calculated from the mass and analysis of the liquid products and compositional information of the gas product, based on which the yield profile was calculated. It was found that the hydrocarbon liquid product contained essentially no oxygen (below the detection limit of the instrument or <0.01 wt %), and the aqueous product produced contained only 0.01 wt % carbon. Thus, complete hydrodeoxygenation of the biomass was achieved producing an oxygen-free hydrocarbon product, and substantially carbon-free aqueous phase. Results for the catalyst in Example 1 are given in Table 2.

Table 2 also contains “standard range” results which are expected levels obtained when a typical hydrotreating catalyst containing cobalt and molybdenum on alumina (CAT A) is used as the first stage ‘hydropyrolysis’ catalyst.

TABLE 2

| | | Catalyst from |
|---|---|---|
| Parameter | Standard Range | Example 1 |
| Feedstock | Pinus Sylvestris | Pine Saw Dust |
| First Stage Catalyst | CAT A | Catalyst from |
| | | Example 1 |
| Second Stage | CAT B | CAT B |
| Catalyst | | |
| Hydrogen addition | 4-6 | 5 |
| (% wof MAF) | | |
| 1^{st} Stage WABT (° C.) | 400-430 | 415 |
| 2^{nd} Stage WABT (° C.) | 340-370 | 360 |
| Pressure (barg) | ~22.4 | 22.4 |
| C4+ Hydrocarbon | 24-28 | 26.5 |
| yield(% wof MAF) | | |
| C1-C3 Hydrocarbon | 10-20 | 13.2 |
| yield(% wof MAF) | | |
| CO + CO₂ Yield(% wof | 1-10 | 7.8 |
| MAF) | | |
| Water yield(% wof | 35-50 | 39.6 |
| MAF) | | |
| Char yield | 10-20 | 12.2 |

These results demonstrate that the catalyst made in Example 1 provides results in the conversion of biomass, via hydrodeoxygenation, hydropyrolysis and hydroconversion processes, that are within desirable ranges when compared to a standard process. However, the catalyst made in Example 1 has a higher particle density (2 g/cm³) compared to a standard catalyst (CAT A-1 g/cm³) used in a typical process. This allows an improved downcomer flux in a fluidised bed reactor and excellent fluidisation behaviour within the bed, providing efficient heat management across the reactor system.

### Example 2

A number of hydropyrolysis catalysts were prepared. The formulation of these catalysts is set out in Table 3. Examples 2A, 2B and 2C were catalysts according to the present invention. Catalyst A is a typical hydrotreating catalyst containing cobalt and molybdenum on alumina (CAT A).

TABLE 3

| | Cat A | Ex. 2A | Ex. 2B | Ex. 2C |
|---|---|---|---|---|
| Co, wt % | 2.3 | 0 | 0 | 2.3 |
| Mo, wt % | 8.0 | 0 | 5.0 | 8.0 |
| Ni, wt % | 0 | 6.4 | 3.8 | 0 |
| W, wt. % | 0 | 35 | 35 | 30 |
| P, wt % | 1.3 | 0 | 1.3 | 1.3 |
| Compacted Bulk density, | 0.67 | 1.13 | 1.17 | 1.18 |
| g/cc | | | | |
| Particle density, g/cc | 1.0 | 1.77 | 1.83 | 1.84 |
| Water Pore volume, cc/g | — | 0.34 | 0.3 | 0.3 |
| BET Surface area, m²/g | 200 | 125 | 75 | 88 |
| BET PV, cc/g | 0.6 | 0.25 | 0.2 | 0.19 |

The catalysts were used as hydropyrolysis catalysts in a bubbling fluidised bed reactor in the same manner as set out in Example 1. The results of the Example 2 are shown in Table 4.

As well as demonstrating excellent hydropyrolysis results in line with those expected for a standard hydropyrolysis catalyst, as set out in “standard range” and demonstrated for CAT A, the catalysts made in a two step process requiring the impregnation of tungsten followed by further impregnation of other metals produced a product slate with a considerably increased gasoline to diesel ratio. This ratio is considered as the amount of C4-C10 to C11+ hydrocarbons formed.

TABLE 4

| | Standard | | | | |
|---|---|---|---|---|---|
| Parameter | Range | Example 2 catalysts | | | |
| Feedstock | Pinus Sylvestris | | | | |
| First Stage | COMo | CAT A | Ex 2A | Ex 2B | Ex 2C |
| Catalyst | | | | | |
| Second Stage | NiMo | CAT B | CAT B | CAT B | CAT B |
| Catalyst | | | | | |
| Hydrogen | 4-6 | 5.6 | ~5 | ~5 | ~5 |
| addition (% wof | | | | | |
| MAF) | | | | | |
| 1^{st} Stage WABT | 400-430 | 415 | 420 | 424 | 424 |
| (° C.) | | | | | |
| 2^{nd} Stage WABT | 340-370 | 361 | 362 | 364 | 363 |
| (° C.) | | | | | |
| Pressure | ~22.4 | 22.4 | 22.3 | 22.3 | 22.3 |
| (barg) | | | | | |
| C4+ | 24-28 | 25 | 27.0 | 26.3 | 26.5 |
| Hydrocarbon | | | | | |
| yield(% wof | | | | | |
| MAF) | | | | | |
| Gasoline to | 7 | 74:26 | 84:16 | 82:18 | 81:19 |
| diesel ratio | | | | | |
| (wt:wt)* | | | | | |
| C1-C3 | 10-20 | 16.9 | 15.3 | 14.6 | 13.2 |
| Hydrocarbon | | | | | |
| yield(% wof | | | | | |
| MAF) | | | | | |
| CO + CO₂ | 1-10 | 4 | 9.2 | 7.8 | 7.8 |
| Yield(% wof | | | | | |
| MAF) | | | | | |
| Water | 35-50 | 43.8 | 42.1 | 39.8 | 39.6 |
| yield(% wof | | | | | |
| MAF) | | | | | |
| Char yield | 10-20 | 12.4 | 10.7 | 11.1 | 12.2 |
| (% wof MAF) | | | | | |

1. A process for the hydropyrolysis of biomass, said process comprising the steps of contacting biomass with a hydropyrolysis catalyst in a bubbling fluidised bed reactor under a hydrogen atmosphere, wherein the hydropyrolysis catalyst is prepared by a process comprising the steps of impregnating a gamma alumina carrier with a first impregnation solution comprising a tungsten salt, drying the tungsten-impregnated carrier; then impregnating the dried tungsten-impregnated carrier with a second impregnation solution comprising a source of a metal selected from those in groups 8, 9 and 10 of the periodic table, and, optionally, a molybdenum source, drying the fully impregnated carrier and then calcining it.

2. A process as claimed in claim 1, wherein the second impregnation solution also comprises a molybdenum source.

3. A process as claimed in claim 1, wherein the metal selected from those is groups 8, 9 and 10 is selected from cobalt and/or nickel.

4. A process as claimed in claim 1, wherein the second impregnation solution also comprises a phosphorus source.

5. A process as claimed in claim 1, wherein the tungsten salt is present in the first impregnation solution in an amount that would result in tungsten being present in the hydropyrolysis catalyst in an amount in the range of from 10 to 35 wt %, based on the overall weight of the catalyst.

6. A process as claimed in claim 1, wherein the tungsten salt is selected from ammonium metatungstate, tungstic acid and mixtures thereof.

7. A process as claimed in claim 1, wherein the gamma alumina carrier is in the form of spherical carrier particles with an average particle diameter in the range of from 0.45 to 0.55 mm.

8. A process as claimed in claim 1, wherein bubbling fluidised bed reactor is operated at a temperature in the range of from 330° C. to 500° C., a pressure in the range of from 0.50 to 7.50 MPa and at a weight hourly space velocity in the range of from 0.1 h-1 to 10 h-1.

9. A process as claimed in claim 1, wherein the process for the hydropyrolysis of biomass produces an output from the bubbling fluidised bed reactor comprising a partially deoxygenated hydropyrolysis product, at least one non-condensable gas, char particles and catalyst particles.

10. A process as claimed in claim 9, wherein the catalyst particles are removed from the output and returned to the bubbling fluidised bed reactor.

11. A process as claimed in claim 9, wherein the partially deoxygenated hydropyrolysis product is subjected to a subsequent hydroconversion process.
